(19) United States
(12) Patent Application Publication
(10) Pub. No.: US 2023/0226932 A1
(43) Pub. Date: Jul. 20, 2023

(54) MOBILE ELECTRIC VEHICLE (EV) CHARGING STATION (POWER POD) SYSTEM AND METHOD

(71) Applicants: Jacob H. Eggleston, Overland Park, KS (US); Jonathan B. Eggleston, Overland Park, KS (US)

(72) Inventors: Jacob H. Eggleston, Overland Park, KS (US); Jonathan B. Eggleston, Overland Park, KS (US)

(21) Appl. No.: 18/097,430

(22) Filed: Jan. 16, 2023

Related U.S. Application Data
(60) Provisional application No. 63/299,777, filed on Jan. 14, 2022.

(51) Int. Cl. B60L 53/16; B60L 53/66

(52) U.S. Cl. CPC B60L 53/16; B60L 53/665; B60L 2210/40; B60L 2240/622

(57) ABSTRACT

A portable power pod charging system for an electric vehicle (EV) includes a power charging circuit with 120V/240V/480V inputs and a transformer. A battery array includes multiple batteries connected in parallel and/or series configurations. An enclosure for the power charging circuit can be mounted on wheels for portability. The system can include a payment module and a global navigation satellite system (GNSS) locator module.

### CROSS-REFERENCE TO RELATED APPLICATION

This application claims priority in U.S. Provisional Patent Application No. 63/299,777, filed Jan. 14, 2022, which is incorporated herein by reference.

### BACKGROUND OF THE INVENTION

### 1. Field of the Invention

The present invention relates generally to electrical power management, and in particular to a system and method for providing mobile electric vehicle (EV) charging station power pods. The invention includes a business model for optimizing revenue potential with such a charging station system.

### 2. Description of the Related Art

EVs are increasingly popular, partly due to environmental considerations. EVs provide additional advantages, including relatively quiet operation, independence from fossil fuels and cost-effective transportation.

With the increasing popularity of EVs for local and long-distance travel, the network of electrical charging station has grown correspondingly. For example, many businesses provide such services for their customers and guests.

The infrastructure required to install, operate, and maintain such charging stations can be relatively expensive and time-consuming for procuring the necessary permits and approvals. The present invention provides a relatively cost-effective charging system network consisting of individual power pods. Such power pods can be utilized by individuals at various locations. Due to their portability, applications include residences (e.g., houses, condominiums, and apartments), businesses, offices, institutions, facilities and other venues.

Heretofore there has not been available a system or method for a charging EVs with the advantages and features of the present invention.

### BRIEF SUMMARY OF THE INVENTION

The present invention generally provides a mobile electric vehicle (EV) charging station system and method. The system is adaptable and scalable for accommodating EVs produced by different manufacturers with various stored power requirements. The charging station system is configured for discharging electrical charging power at relatively high levels for relatively fast charging cycles.

### BRIEF DESCRIPTION OF THE DRAWINGS

The drawings constitute a part of this specification and include exemplary embodiments of the present invention illustrating various objects and features thereof.

FIG. 1 is a circuit diagram of a charging station embodying an aspect of the present invention, shown configured for 120 V, 240 V or 480 V electrical source input.

FIGS. 2A and 2B are a table showing exemplary charge pod (charging station) specifications.

FIG. 3 shows an example of a portable power pod embodying an aspect of the present invention in a water-resistant enclosure.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Said terminology will include the words specifically mentioned, derivatives thereof and words of similar meaning.

### II. Preferred Embodiment Mobile EV Charging Station System 2

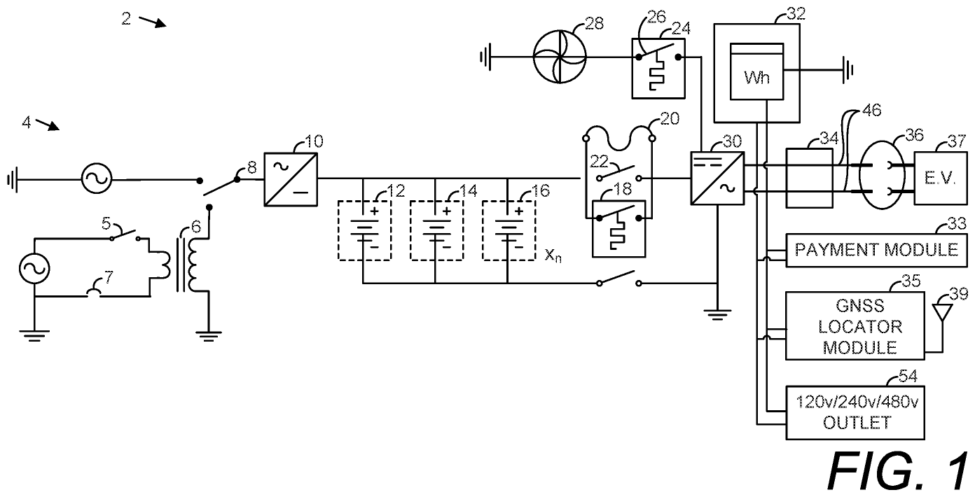

Without limitation on the generality of useful embodiments and applications of the present invention, a schematic diagram of a mobile electric vehicle charging station (power pod) 2 is shown in FIG. 1. The charging station 2 includes an AC power subsystem 4 configured for connection to 120 V AC, 240 V AC, or 480 V AC. 120V/240V input can be stepped up to 240V/480V output through a transformer 6, which can be selectively energized via a switch 5 and protected by a circuit breaker 7. A power source switch 8 is provided for switching among different AC power inputs.

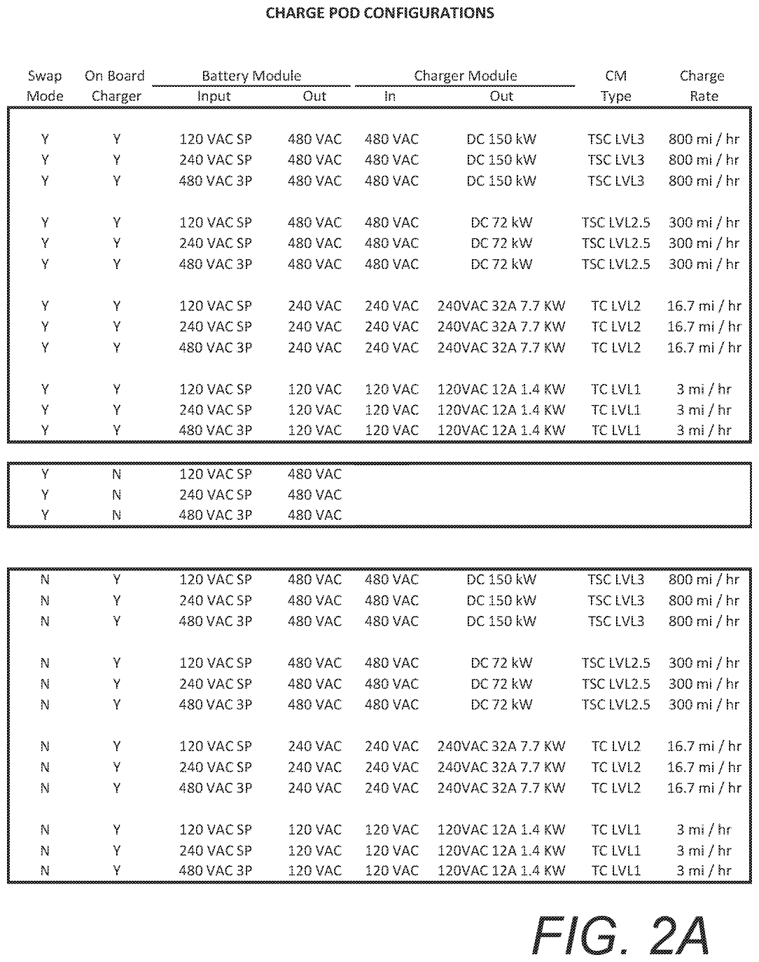

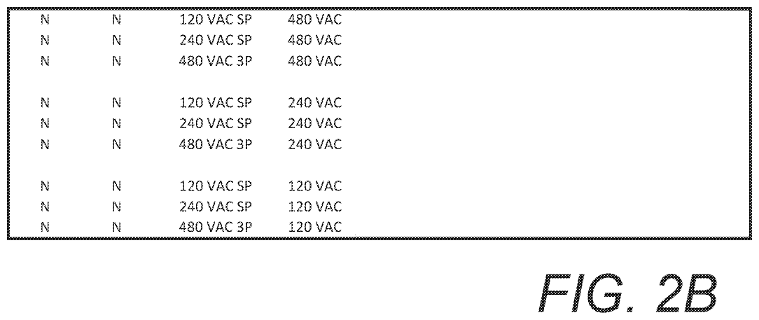

Electrical current from the input power subsystem 4 is received by a rectifier 10, which is connected to rechargeable batteries. Without limitation on the generality of useful configurations, batteries, 12, 14 and 16 are shown, connected in parallel. Alternatively, battery arrays can be configured with parallel and/or series connections. A temperature switch 18 is normally closed and opens in the event of an overheat condition. A fuse 20 protects the circuit. Switches 22 are provided for energizing output from the circuit. FIGS. 2A and 2B are a table showing exemplary charge pod (charging station) specifications.

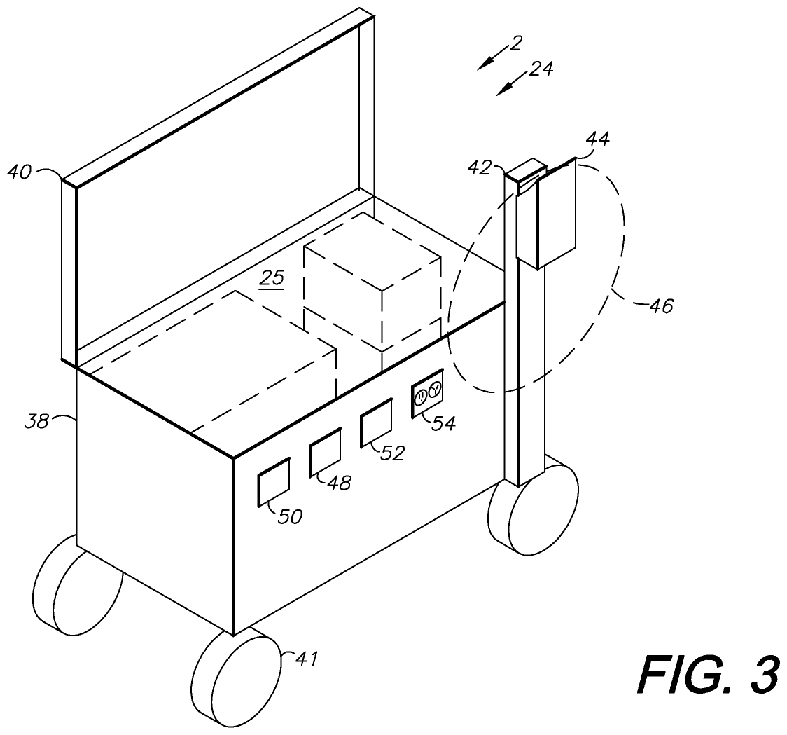

The charging station 2 can be housed in an enclosure 24 (FIG. 3), which can include a normally-open temperature-responsive switch 26 for activating a cooling fan 28 when the internal temperature in the enclosure 24 exceeds a predetermined limit. The charging station 2 includes a DC/AC inverter 30 and a watt-hour meter 32 configured for monitoring power usage by the station 2. A charger 34 is configured for charging an EV 37. The rechargeable batteries of the EV 37 are connected to the charging station 2 by a suitable plug-type connector 36.

The charging station 2 can include an optional payment module 33 connected to the watt-hour meter 32 for monitoring actual power usage and receiving payment via a card reader, a keyboard, a PIN device, a scanner or some other suitable input device. Alternatively, the payment module can include a timer, thus enabling users to purchase electrical power for predetermined charging durations. An input/output port 52 is connected to the charging circuit and mounted on the enclosure 24. A 120V/240V outlet 54 is connected to the charging circuit and mounted on the enclosure 24 for external access.

The charging station 2 can also include a Global Navigation Satellite System (GNSS) (e.g., the U.S.-based Global Positioning System (GPS)) positioning device 35 with an antenna 39, which can transmit the location of the charging station 2. Moreover, the system 2 can be integrated with an area-wide system for tracking and monitoring vehicle and transmitting the locations of power pods. Motorists can thus efficiently plan trip-routing to optimize travel time with sufficient electrical power charges for optimum vehicle operation.

FIG. 3 shows an example of a suitable configuration for the enclosure 24 with a generally hexahedron-shaped base 38, which can be selectively closed with a hinged lid 40. The enclosure 24 encloses a compartment 25 for securely housing the charging station 2 components. The enclosure can be weathertight for exterior applications. Suitable locking latches can be provided for security. The enclosure 24 can be provided with wheels 41 for portability. Alternatively, the enclosure 24 can be fixedly mounted or attached to a structure, such as a garage.

A mast 42 is provided at a corner of the enclosure base 38 and terminates at a masthead 44 configured for coiling or draping the power output lines 46 in a storage configuration. A user-customer can extend the lines 46 to an EV. The enclosure 24 can mount controls and instruments for controlling and monitoring operation, e.g., a charge level indicator 48. Switchgear 50 is provided for on/off functions, switching among 120/240/480 power sources, resetting and scheduling charging cycles. Still further, an input/output port can be provided for linking multiple power pods 2, e.g., in a “daisy-chain” configuration.

### III. Conclusion

It is to be understood that while certain embodiments and/or aspects of the invention have been shown and described, the invention is not limited thereto and encompasses various other embodiments and aspects. For example, the system and method of the present invention can be adapted for a wide range of applications, including passenger vehicles, trucks for hauling cargo, golf carts, marine vessels, aircraft, trains, etc.

1. A power pod station for charging an electric vehicle (EV) from a power source, which charging station comprises:
an enclosure defining an enclosed compartment;
a power charging circuit in said enclosed compartment, which includes: a transformer configured for connecting to said power source; a rectifier connected to said transformer; an electrical power storage component connected to said rectifier; a DC/AC inverter connected to said electrical power storage component; a charger connected to said DC/AC inverter; and an output port connected to said charger; and
a power output line connected to said output port and configured for connecting to an EV.

2. The power pod station according to claim 1, which includes:
said transformer configured for receiving 120V/240V/480V input electrical current.

3. The charging station according to claim 1, which includes:
an enclosure with a base, a lid connected to said base; and an enclosure compartment; and
said lid having open and closed positions respectively providing access to and enclosing said enclosure compartment.

4. The power pod station according to claim 3 wherein said enclosure compartment includes:
a transformer circuit,
a rectifier connected to said transformer circuit and configured for rectifying AC input to DC output;
an electric power storage component connected to said rectifier DC output;
an inverter connected to said electric power storage component;
a battery charging component connected to said DC/AC inverter; and
a power output line connected to said DC/AC inverter and configured for connection to said EV.

5. A power pod station for charging an electric vehicle (EV) from a power source, which charging station comprises:
an enclosure defining an enclosed compartment;
a power charging circuit in said enclosed compartment, which includes: a transformer configured for connecting to said power source, said transformer configured for receiving 120V/240V/480V input electrical current; a rectifier connected to said transformer; an electrical power storage component connected to said rectifier; a DC/AC inverter connected to said electrical power storage component; a charger connected to said DC/AC inverter; and an output port connected to said charger;
a power output line connected to said output port and configured for connecting to an EV;
an enclosure with a base, a lid connected to said base; and an enclosure compartment;
said lid having open and closed positions respectively providing access to and enclosing said enclosure compartment;
a mast mounted on said enclosure base and extending upwardly from said enclosure base to a mast upper end;
a masthead mounted on said mast upper end and configured for selectively receiving a power output line in a coiled, storage configuration;
multiple wheels mounted on said enclosure base;
a payment module connected to said power charging circuit and mounted on said enclosure base;
a charge level indicator connected to said power charging circuit and mounted on said enclosure base;
switchgear connected to said power charging circuit and mounted on said enclosure base, said switchgear configured for activating and controlling operation of said power charging circuit;
a global navigation satellite system (GNSS) locator connected to said power charging circuit and configured for transmitting a GNSS-defined location of said power pod station; and
a 120 V/240 V outlet connected to said power charging circuit and mounted on said enclosure base.
